(19) United States
(12) Patent Application Publication
(10) Pub. No.: US 2013/0141212 A1
(43) Pub. Date: Jun. 6, 2013

(54) VEHICLE ACCESS

(71) Applicant: Carl Pickering, Whitley Coventry Warwickshire (GB)

(72) Inventor: Carl Pickering, Whitley Coventry Warwickshire (GB)

(73) Assignee: JAGUAR CARS LTD., Whitley Coventry Warwickshire (GB)

(21) Appl. No.: 13/700,581

(22) PCT Filed: May 26, 2011
(86) PCT No.: PCT/EP11/58673

§ 371 Date: Feb. 13, 2013

(30) Foreign Application Priority Data
May 28, 2010 (GB) 1009014.0

(51) Int. Cl. G05B 1/01

(52) U.S. Cl. CPC G05B 1/01
USPC 340/5.61

(57) ABSTRACT

A case for a mobile telephone or other nomadic device, the case comprising communication means for wirelessly communicating with a security and/or access system of a vehicle or property. The communication means may be embedded within the material forming the case or may be retained in a slot or recess within the case. The communication means comprises means arranged to transmit control or operation commands to the vehicle or property so as to operate or control one or more functions or devices. The case may comprise one or more buttons or switches configured to be actuated by the user to transmit said commands. A mobile telephone or other nomadic device having such a case. A vehicle adapted to work with a mobile telephone or a case as described hereinbefore.

The present invention is concerned with improvements in or relating to vehicle access. More specifically, but not exclusively, the invention concerns an improvement to so-called “passive entry” or “keyless entry” vehicle access or security systems. Aspects of the invention relate to an apparatus, to a cover, case or holder for a nomadic device and to a device having such a cover, case or holder.

For many years, vehicles such as automobiles employed conventional “lock and key” systems for locking and unlocking the vehicle doors and turning on the ignition. Each door of the vehicle, as well as the ignition switch, was provided with a barrel lock into which a unique key could be inserted and turned thereby to lock/unlock the doors or to switch on the ignition, respectively.

Improvements in electronics systems led to the introduction of remote locking systems known generally as “keyless entry” (KE) systems, involving a transmitter unit in a key fob held by the vehicle user and a receiver unit located within the vehicle. In such systems, the transmitter unit is arranged to transmit an identification signal to the receiver unit in response to the user actuating a button on the key fob. On receipt of the identification signal by the receiver unit, a control unit in the vehicle causes the vehicle doors to unlock or lock, depending on the current locked/unlocked state of the vehicle. The key can be used to lock/unlock the vehicle doors in the conventional manner and is, in general, required to switch on the ignition.

More recently still, so-called “passive keyless entry” (PKE) systems have been introduced which remove entirely the requirement for a key to lock or unlock the vehicle doors, or even to switch on the ignition. Instead, the user carries a small user transceiver unit known as a token which communicates with a further transceiver unit located within the vehicle. The vehicle transceiver unit (VTU) detects the proximity of the token and, if the latter is within a certain distance or threshold range of the vehicle, unlocks the vehicle doors either automatically, or on actuation of a button or switch located on the vehicle itself, often the door handle. Furthermore, sensors within the vehicle detect the presence or absence of the token within the vehicle cabin and only permit the switching on of the vehicle ignition if the token is detected as being within the cabin.

In many passive keyless entry systems, although access to the vehicle can be achieved without manipulation of the token by the user, the token carries a number of buttons or switches to permit the user to wirelessly transmit certain control commands to the vehicle, such as “manually” locking or unlocking the vehicle doors, opening the luggage compartment, setting the alarm or operating the vehicle lights, without being within the threshold range of the vehicle. In addition, the token often includes a mechanical key for emergency access to the vehicle in the event of power or system failure. In this respect, these devices combine the functions of both KE and PKE systems and are thus sometimes referred to in the art as “Smart Key Fobs”. All of the above described systems are well known in the art.

PKE tokens can be extremely small in size and light in weight, making them easy to carry on the user's person comfortably and discretely. On the other hand, their small size makes them easy to misplace, an inconvenience which can result in access to the vehicle being prevented.

Smart key fobs, on the other hand, tend to be larger, heavier devices due to the need to include user actuable buttons or switches and, in some cases, a mechanical key for emergency access. While this makes them less likely to be misplaced, users may find it inconvenient to carry such relatively bulky items on their person, particularly as most users today tend to carry a range of other personal items with them such as wallets, mobile telephones and other nomadic devices.

Proposals have previously been put forward to incorporate the transceiver units of the smart key fobs into mobile telephones or other nomadic devices, thereby reducing number of personal items required to be carried by the vehicle user.

However, the present applicant has identified a number of problems with such arrangements. Specifically, the cost of implementation of such solutions is prohibitively high, since the physical incorporation of a transceiver unit into a mobile telephone or other nomadic device usually requires substantial redesign. Applying such technology to existing mobile devices is thus extremely difficult and may require the user to purchase a new device, increasing user cost.

In addition, the user is generally unable to grant vehicle access to others, such as family members or friends, without having to lend them their mobile device, something which many users would find inconvenient or undesirable.

It is an aim of the present invention to address one or more of these problems. Embodiments of the invention may provide a cover, case or holder for a mobile telephone or other nomadic device which incorporates a transceiver or transponder unit for remotely accessing a vehicle or other property. Other aims and advantages of the invention will become apparent from the following description, claims and drawings.

Aspects of the invention therefore provide an apparatus, a cover, case or holder for a mobile telephone or other nomadic device, a device and a vehicle as claimed in the appended claims.

Throughout this application, the term “case” is used as a general term to refer to any form of cover, case or holder for a mobile telephone or other mobile communications or nomadic device. It is not intended to be limiting in any way.

According to another aspect of the invention for which protection is sought, there is provided an apparatus for holding or protecting a mobile telephone or the like, the apparatus comprising communication means for wirelessly communicating with a security and/or access system of a vehicle

The apparatus may be a case, cover or holder for a mobile telephone or other mobile communications device, a PDA, laptop or other nomadic device.

In an embodiment, the communication means may be arranged to communicate with a Keyless Vehicle Module (KVM) or other vehicle security system so as to permit access to the vehicle.

The case may be arranged to receive and at least partially surround a mobile telephone or other nomadic device in a detachable or removable manner. In an embodiment, the case is arranged to be quickly and easily removed or separated from the mobile device and subsequently quickly and easily attached to another mobile device. This has the effect of enabling the vehicle user to grant access to the vehicle to others without losing possession of his mobile telephone.

In an embodiment, the communication means comprises a transceiver or transponder arrangement for communicating with the security system of the vehicle.

The case may be formed from a generally flexible and/or soft elastomeric or plastics material such as rubber, rubberised gel or the like. In this embodiment, the communication means may be embedded within the material forming the case. For example, during manufacture, the case may be moulded around a PCB or other structure supporting the communication means.

Alternatively, the case may be formed from a harder plastics material such as PET, HDPE, PVC or PP. In this embodiment, the case may comprise a slot or recess for locating or retaining the communication means. The slot or recess may advantageously be disposed in or on a rear cover portion of the case, that is a portion of the case covering the rear surface of the mobile telephone, in use.

The communication means may be formed on a PCB or other supporting structure adapted to be received in the slot or recess. The PCB or other structure may be held within the slot or recess in a substantially permanent manner, so as to hinder or prevent removal thereof. Alternatively, the PCB or other structure may be held within the slot or recess in a manner permitting easy removal thereof.

In an embodiment, the communication means comprises an RFID tag. The RFID tag may be an active or passive device.

In an embodiment, the communication means comprises means for wirelessly communicating with a vehicle ignition system for activating or deactivating the vehicle ignition and/or starting or stopping the vehicle internal combustion engine.

In an embodiment, the communication means may comprise means for transmitting control or operation commands to the vehicle, so as to operate or control one or more vehicle functions or devices.

In this or other embodiments, the case may be provided with one or more buttons or switches actuable by the user to operate or control the communication means. In an embodiment the one or more buttons or switches may be arranged to control the communication means to transmit the control commands to the vehicle.

For example, in an embodiment, the case includes one or more buttons or switches for controlling or actuating one or more of the following vehicle functions:

Lock/Unlock vehicle doors;
Set vehicle alarm and/or immobiliser;
Activate/deactivate vehicle external lights/headlamps;
Activate/deactivate hazard warning lamps;
Lock/Unlock vehicle luggage compartment;
Operate internal illumination;
Cabin Preconditioning, such as seat heating, fan speed, HVAC control etc.

In an embodiment, the case comprises means for reducing and/or preventing unintended operation of the communication means.

For example, in an embodiment, the case includes an “enable”, “confirm” or “send” button or the like for confirming the control command to be sent by the communication means. In this embodiment, a user wishing to send a control command to the vehicle may actuate the relevant button or switch corresponding to the desired function to be controlled. However, the communication means may be arranged to withhold transmitting the requested command until the user presses the confirm button. On actuation of the confirm button, the communication means transmits the control command to the vehicle.

In another embodiment, the control means is arranged to transmit a control command to the vehicle only if the corresponding button or switch is actuated by the user twice within a predetermined period of time, such as one second.

These embodiments may advantageously prevent unintended operation of a vehicle function or device through accidental actuation of one or more buttons or switches on the case.

Within the scope of this application it is envisaged that the various aspects, embodiments, examples, features and alternatives set out in the preceding paragraphs, in the claims and/or in the following description and drawings may be taken independently or in any combination thereof.

The present invention will now be described, by way of example only, with reference to the accompanying drawings, in which:

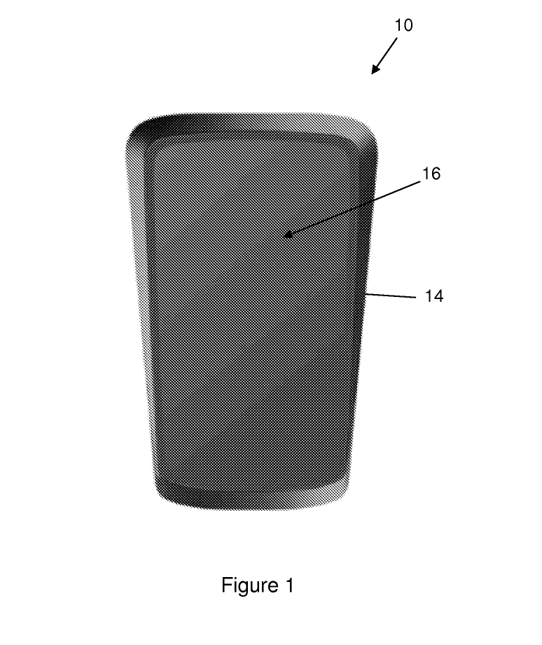

FIG. 1 is a front view of one form of case embodying the invention for use with a mobile telephone or other nomadic device;

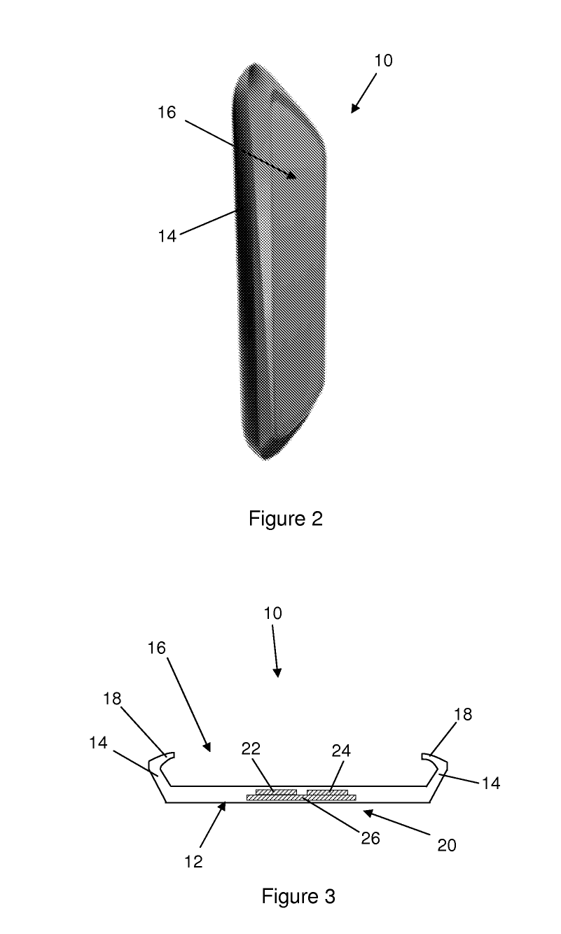

FIG. 2 is a perspective view of the case of FIG. 1;

FIG. 3 is a cross section through the case of FIG. 1 along the line A-A;

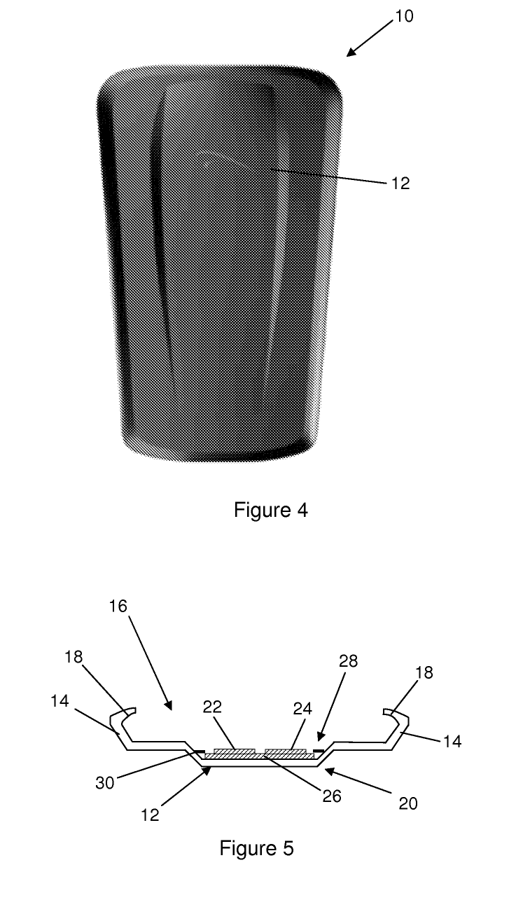

FIG. 4 is a rear view of another form of case embodying the invention;

FIG. 5 is a cross section through the case of FIG. 4;

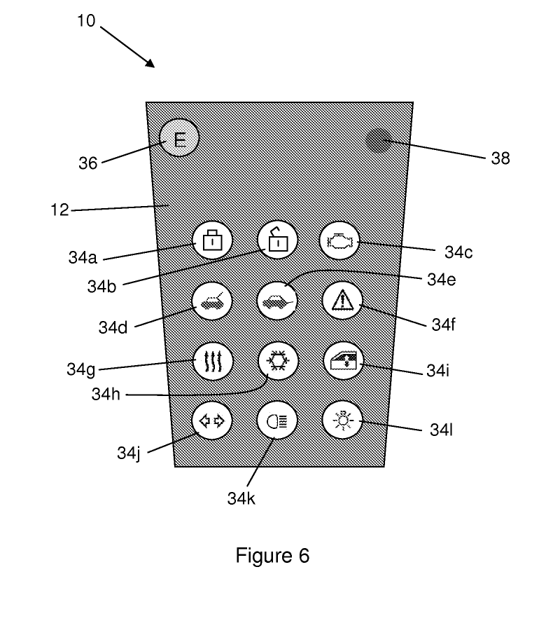

FIG. 6 represents a schematic rear view of another form of case embodying the invention.

Referring firstly to FIGS. 1 and 2, a case for a mobile telephone embodying one form of the invention is shown generally at 10. The case 10 is formed as a shallow, rectangular container having a closed rear face 12 and side walls 14 upstanding therefrom. The front face 16 of the case 10 is open. The side walls 14 of the container are shallow, having a depth significantly less than their length, and curl inwardly at their ends, as best seen in FIGS. 3 and 5, to form a lip 18 extending around the periphery of the open front face 16. The rear face 12 and side walls 14 of the case thus define an open fronted pouch or pocket within which an electronic device, such as a mobile telephone or other nomadic device, may be inserted.

Mobile telephone cases of this type are well known and widely available for purchase. An example is that sold by Apple® for their proprietary iPhone®. It will be appreciated, however, that the precise shape and configuration of the case 10 is not essential and will, in any event, conform generally to the shape and configuration of the model of mobile phone or other nomadic device that it is intended to hold.

According to the present invention, however, the case 10 comprises communication means 20 integrated or contained therein for communicating wirelessly with a security system of a vehicle such as an automobile.

In the illustrated embodiment, the communication means 20 comprises a transceiver or transponder 20 22 and associated circuitry 24 such as that conventionally found in KE systems, PKE systems or smart key fobs described above, hereafter termed “transponder”. For completeness, the term transponder is used to refer to any electronic circuit or device which is arranged to receive and transmit wireless signals from and to a host, such as a vehicle, in order to operate various vehicle functions, such as door locking and unlocking. The term is not intended to be limiting in any way

The transponder is supported upon a PCB 26 or other substrate and is secured to the inside surface of the case 10 in a suitable location. Preferably, but not essentially, the PCB 26 and the components 22, 24 making up the transponder 20 mounted thereon are miniaturised to reduce packaging space and component weight. This may include surface-mounting components onto flexible PCBs 26 and employing small, lightweight batteries (not shown) such as ultra-thin lithium polymer cells.

As shown in FIG. 3, which illustrates a cross section through the case 10 of FIG. 1, the PCB 26 on which the transponder 20 is mounted is disposed in a central region of the rear face 12 of the case 10. More specifically, the case 10 is formed from a flexible, elastomeric material such as rubber or a soft plastics material. During manufacture, the body of the case 10 is moulded around the PCB 26 and transponder 20 which are thus embedded in, or integral with, the material forming the rear face 12 of the case 10.

Since the material from which the case 10 is formed is both waterproof and electrically insulative, this arrangement advantageously maintains the PCB 26 and electronic components 22, 24 of the transponder 20 in a protective environment, thereby reducing the likelihood of short-circuit or other malfunction or failure.

FIGS. 4 and 5 show an alternative form of case 10 embodying the invention. In this embodiment, a slot or recess 28 is formed in the rear face 12 of the case 10 in which the PCB 26 carrying the transponder 20 is seated. This embodiment may be more suitable for cases formed from a harder material, such as PET, HDPE, PVC or PP, or a material that is, for example, vacuum formed or blow moulded rather than injection moulded.

Retaining features may be built into the recess 28, for example one or more inwardly directed lips or detents 30, for retaining or securing the PCB 26 in the recess 28. The retaining features 30 may be arranged to provide substantially permanent retention of the PCB 26 in the recess 28, for example to prevent removal without destroying the case 10 and/or the PCB 26 and transponder 20. Alternatively, the retaining features 30 may be arranged to provide releasable retention of the PCB 26 so that the transponder 20 can be swapped between cases 10 if desired. This arrangement advantageously permits users to incorporate the vehicle access function into a new case when their mobile telephone is upgraded or changed.

In terms of the functionality of the transponder 20, this will depend upon the nature of the transponder components 22, 24 themselves. If the transponder 20 used is that of a conventional RFID tag, then functionality may be limited simply to the vehicle doors being unlocked when the case 10, and thus the transponder 20, comes within a predetermined range of the vehicle.

On the other hand, if the transponder 20 incorporated into the case 10 is similar or identical to that used in a smart key fob, described above, then numerous additional functionalities may be provided, optionally requiring additional modification to the case 10.

In this respect, it is envisaged that various embodiments or examples of the invention may be realised.

### EXAMPLE 1

In this example, the communication means comprises a simple RFID tag. RFID tags (also known as passive tags or proximity tags) are well known transponder devices which are energised by the electromagnetic signals transmitted by an interrogating or reading device. In the case of the present invention, the interrogating or reading device is the transponder arrangement located in the vehicle.

When the case 10 containing the RFID tag is within a predetermined range of the vehicle, usually in a position close to the door handle of the vehicle, the RFID tag responds to an interrogation from the vehicle transponder by transmitting an identification signal to the vehicle. When received, the vehicle security system locks or unlocks the vehicle doors depending on the current lock/unlock status of the vehicle. This functionality and method of operation is well known.

To maintain appropriate security levels, the use of a passive RFID tag as the communication means in this embodiment may permit only limited functionality, such as locking or unlocking the vehicle doors and luggage compartment, and a conventional KE, PKE or smart key fob may be required to start the vehicle. However, since access to the vehicle is gained only by the transponder 20 within the case 10, the additional PKE or smart key fob could readily be kept inside the vehicle even when locked so that only the mobile telephone case 10 with the integrated RFID tag need be carried.

Furthermore, as a passive device that draws power from the electromagnetic signals transmitted by the vehicle-mounted transponder unit, the RFID tag does not require a separate power source such as a battery and can therefore be made extremely small, slim and light so as not to adversely affect the size, shape or weight of the case 10.

Nevertheless, an active RFID tag could also be used. While this would require a battery to be provided on the PCB 26 or within the case 10 and would not necessarily increase functionality, operational range would be substantially increased.

For completeness, a non-limiting description of a method of operation of the present invention according to EXAMPLE 1 is provided below:

### A) Locking the Vehicle

The user locates the conventional smart key fob securely inside the vehicle, for example in the glove box since this is locked when the vehicle is locked. The user then exits the vehicle as normal and holds the case 10, having the integrated RFID tag, close to the door handle in order to lock the vehicle as described above.

Preferably, but not essentially, the vehicle is locked using the RFID tag in the case 10 and not the lock button on the door handle so that both the smart key fob and RFID tag cannot be accidentally left in the vehicle which would have the effect of locking the user out. If the case 10 is left inside the vehicle then the lock button on the handle does not work.

When the RFID tag in the case 10 is used to lock the vehicle, the vehicle security system is arranged to poll the RFID tag to check its validity. If the tag is valid, the system checks to see that the smart key fob is located inside the vehicle and, if so, locks the vehicle in the normal manner and feedback such as indicator flash or door mirror fold, is provided to the user.

Alternatively, or in addition, an audible indicator may be provided if the door handle lock button is pressed to lock the vehicle whilst the smart key fob is still inside. This indicates to the user that vehicle is not locked and that they must hold the case 10 containing the RFID tag against the door handle.

When the vehicle is locked using the RFID tag in the case 10, the smart key fob retained in the vehicle may be de-activated so that the vehicle cannot be started without first being unlocked with the RFID tag.

### B) Unlocking the Vehicle

The user approaches the vehicle as normal and holds the case 10 with the integrated RFID tag close to the antenna location, for example the door handle or boot release. When the RFID tag has been polled and authenticated by the vehicle security system, the vehicle doors are unlocked and feedback is provided to the user, for example indicators flash, door mirrors unfold, etc.

In addition, if the smart key fob inside the car has been disabled on locking, it may be re-activated on unlocking to allow the vehicle to be started.

### C) Power Management

When the vehicle is locked with the RFID tag in the case 10, the antenna in the vehicle may poll for an RFID tag for a predetermined time, for example up to two days. After expiry of this predetermined period, the system may power down to conserve the vehicle battery life. If the system has powered down it may re-start polling for an RFID tag by a pull on the door or boot handle. If the vehicle battery is completely flat then the system may be re-activated with a re-charge of the vehicle battery.

### EXAMPLE 2

In this example, the communication means comprises an active transponder powered by a slim battery or power cell, such as an ultrathin lithium polymer cell. The transponder 20 may be similar or identical to the transponder device used in a standard PKE system which will be well understood by the skilled person.

In this case, the additional security provided by the active transponder 20 may allow for greater functionality enabling the user not only to lock and unlock the vehicle doors but also to start the vehicle engine. Since all of the essential functions of the PE and PKE systems, that is door lock and unlock and engine start, are provided by the communication means in the case 10, a separate smart key fob is not required, meaning that only a single item (the case 10) need be carried by the user. Storing a separate smart key fob in the vehicle to enable vehicle start is not necessary.

### EXAMPLE 3

In this example, the communication means integrated with the case 10 provides at least the same functionality as a conventional smart key fob. For example, the transponder 20 is an active system powered by a slim power cell or battery and is able to control a plurality of vehicle systems or devices in addition to conventional door lock/unlock and engine start, such as activating the vehicle headlamps or hazard warning lamps, operating the internal illumination system, preconditioning the cabin, opening or closing a convertible roof, activating a panic alarm, controlling electric window operation, opening or closing an electric dual tail gate, performing an external lamp test, etc.

In this example, the case 10 is provided with a plurality of buttons, pads or switches, substantially identical in purpose and function to the buttons or switches provided on a conventional smart key fob. These, when actuated by the user, enable one or more vehicle functions, such as those listed above, to be activated or deactivated.

In the non-limiting embodiment illustrated in FIG. 6, the buttons are provided on the rear face 12 of the case 10 in the form of flush or raised pads 34. Advantageously, the large surface area of the rear face 12 of the case 10 compared to conventional smart key fobs provides space for a relatively large number of buttons, potentially enabling greater and/or more simple functionality.

In the embodiment of FIG. 6, the case 10 includes an array of twelve buttons 34a-34l on its rear surface 12. Each button 34a-34l corresponds to one or more functions or devices on the vehicle which can be activated, operated or controlled by actuation of the corresponding button. Each button includes a graphical icon or symbol representing the vehicle function or device activated or controlled by the button.

In FIG. 6, the case 10 comprises the following buttons:

34a) Door lock;
34b) Door unlock;
34c) Engine start/stop
34d) Upper tailgate open/close;
34e) Lower tailgate open/close;
34f) Panic function (operate hazard lamps, vehicle horn etc.);
34g) Cabin preconditioning—increase temperature;
34h) Cabin preconditioning—decrease temperature;
34i) Electric window open/close;
34j) Lamp test—indicator lamps;
34k) Lamp test—head lamps;
34l) Lamp test—brake lamps;

The functions 34j)-34l) above, that is the testing of individual lamp systems on the vehicle, are believed to be novel and inventive. For example, actuating the button 34l) causes the transponder 20 to transmit a wireless command to the vehicle to illuminate the vehicle brake lamps. On receiving the command, the vehicle security system transmits the command to the relevant microcontroller or system that controls the brake lamps to cause them to illuminate. This arrangement advantageously permits the user to check the correct functioning of the brake lamps single-handedly, obviating the conventional requirement for a second person to monitor the rear of the vehicle while the driver presses the brake pedal.

This wide range of functions available from the invention is achieved, at least in part, by disposing the buttons 34a-34l on the rear face 12 of the case 10, which has sufficient area to permit a large number of buttons to be provided.

The applicant has recognised that the position of the buttons 34a-34l on the rear surface 12 of the case 10 may render them susceptible to inadvertent actuation, for example when the users mobile phone, and thus the case 10, is being carried in a pocket or bag. Accidental actuation of, for example, the door unlock or window control buttons 34b, 34i may compromise vehicle security.

In the embodiment of FIG. 6, therefore, means are provided to hinder or prevent unintended activation, operation or control of vehicle functions or devices through accidental actuation of one or more of the buttons 3a)-3l). More specifically, in addition to the buttons 3a)-3l), the case 10 includes an additional button 36, which may conveniently be termed an “enable” or “confirm” button.

In this embodiment, actuation of a button 34a)-34l) does not generate the above-described command signal unless the enable button 36 is simultaneously held down, or actuated within a predetermined period thereafter, for example 1 second. In an alternative embodiment, the enable button 36 is eliminated and the transponder 20 is arranged so that the control signal is not transmitted unless the relevant button 34a)-34l) is actuated (pressed) twice in quick succession, e.g. within 1 second.

It will be appreciated by those skilled in the art that the buttons provided in Example 3 and shown in FIG. 6 can be used in any of the embodiments disclosed herein, including the cases 10 described with reference to FIGS. 1 to 5.

As described above, embodiments of the present invention provide a removable cover or casing for a mobile telephone or other nomadic device comprising an integrated electronic device, such as a transceiver or transponder 20, for permitting access to an automotive vehicle or other property and, optionally, a user control interface (buttons 34a-34l, 36). In one embodiment, the case 10 comprises a rubber gel or other flexible-material sleeve having an encapsulated PCB 26 with a transponder 20 for communicating with the vehicle security systems such as the door locking system, boot release, lighting system and alarm/immobiliser, etc.

It will be understood from the foregoing that the transponder 20 operates in a manner substantially identical to that of transponder or transceiver devices found in conventional RFID tags, KE or PKE systems, or smart key fobs and will thus be well understood by the skilled person. It is the integrating of the communication means, e.g. transponder 20, with the case 10, for example by permanent or releasable attachment, or embedding within the material of the case itself, that is considered to be an important novel and inventive feature of the invention.

By integrating the communication means within the case 10, the number of personal items carried by the user can be reduced. In addition, in contrast with previous proposals to include the communication means within the mobile telephone itself, the user is free to lend the means to access the vehicle to others without the inconvenience of having also to lend the mobile telephone.

Other novel and inventive features of the invention are set out throughout this description, in the statements of invention and in the claims.

Nevertheless, various modifications and improvements may be made to the invention without deviating from the scope of the claims appended hereto.

For example, in the case where the communication means (e.g. transponder 20) is an active unit, requiring a source of electrical power, an on-board battery or power cell (not shown) may be provided on the PCB or elsewhere on the case 10.

Alternatively, or in addition, it is envisaged that the case 10 may comprise an integrated connector (not shown) for connecting directly to a data and/or power connector on the mobile telephone or nomadic device. The connector integrated with the case 10 may be electrically connected to the communication means 20 such that its mating with the data and/or power connector on the mobile telephone enables power to be supplied to the communication means from the mobile phone battery. This may remove the need for an integrated battery within the case 10 or, alternatively, may permit charging of the on board cell from the mobile telephone battery.

In one embodiment, the communication means 20 is arranged to communicate additionally with the mobile telephone or nomadic device. This may be achieved through a wired connection with the mobile telephone, such as that described in the previous paragraph, or a wireless connection via, for example, RFID or Bluetooth. The latter would, of course, require an RFID tag or Bluetooth module (not shown) to be integrated within the case 10. This connection between the communication means 20 and the mobile device could be used for a number of purposes.

In one embodiment, where the mobile device is able to remotely interact with the vehicle, such as described in the applicant's co-pending patent application no. GB1008710.4, the contents of which are expressly incorporated herein by reference, event warnings or alerts transmitted by the vehicle to the mobile device can be indicated by means of an LED or other display device 38 provided on the case 10. For example, a single LED may be provided on the on the rear face or edge of the case 10 which is illuminated when an alert is received by the mobile device that the vehicle is unlocked or the alarm is activated, or if there is a fault requiring attention such as a low battery or flat tyre.

The LED may be replaced by an LCD or dot matrix display for providing more detailed information on the nature of the alert or warning, which could be for any event or fault occurring on the vehicle. Providing such an indicator, even a simple indicator such as a single LED 38, may reduce or obviate the need for the mobile device GUI to be activated or woken up on receipt of an alert, thereby improving battery life for the mobile device.

Alternatively, or in addition, the wired or wireless link between the communication means 20 in the case 10 and the mobile device may be used to enhance the functionality or usability of the invention. For example, if the vehicle is located beyond a predetermined range of the communication means, then actuation of the control buttons 34a)-34l), for example to unlock the vehicle doors, may be ineffective since the control signal is not received by the vehicle transponder unit. In this case, the control signal may be transmitted to the vehicle by the mobile device via the GSM or other cellular network.

Detecting that the original control signal from the transponder 20 in the case 10 was ineffective can be achieved by the mobile device waiting for an event alert from the vehicle that the vehicle doors have been unlocked. If such an alert is not received by the mobile device within a predetermined period of time following actuation of the button on the case 10, the mobile device determines that the instruction has been unsuccessful and transmits the same instruction to the vehicle over the GSM or other cellular network.

In one embodiment, to further increase security, the user is able to operate the mobile telephone or nomadic device to send data to the communication means 20 in the case 10 concerning other users' permissions to access and use the vehicle. For example, the user is able to enter in the mobile device the other users telephone number and the date/time that their use of the vehicle is permitted. This data is transmitted to the communication means 20 in the case 10 and stored in a memory.

When the second user then fits the case 10 to his/her phone, the communication means is arranged to check via the wired or wireless communication link that the number of the linked mobile device is an approved number and that the usage request is within the specified date/time period. This would give assurance to main user that when he loans his/her vehicle to somebody it can only be used by that person carrying an approved mobile device with the appropriate case 10.

In an embodiment, the communication means 20 integrated with the case 10 comprises a validation tag for a conventional stolen vehicle tracker (SVT system). Current SVT systems require a separate validation fob to be carried by the authorised person whenever he/she wishes to use the vehicle. This is inconvenient and leads to many users simply leaving the SVT fob in the glove compartment meaning that in the event of theft of the vehicle, the SVT system fails to detect that the criminal act has taken place. By incorporating the validation tag in a case 10 for the users mobile telephone or other nomadic device, it is less likely that the tag will be forgotten or left in the vehicle, thereby improving convenience and security.

Likewise, some vehicles require separate fobs or devices for activating cabin preconditioning systems such as integrated fuel burners. This function can be incorporated into the communication means integrated in the case 10 which, as with all other embodiments described herein, advantageously reduces the number of items required to be carried by the user.

While the invention has been described above in the context of an access, security or control system for a vehicle such as an automobile, the skilled person will readily appreciate that other advantageous applications of the invention are possible. For example, it is envisaged that the invention may be used for accessing a property or building such as a house or office, the principle again being that by incorporating the access function into the case 10, the user is not required to carry additional items such as electronic keys or passes.

Within this application, the term “communication means” is not intended to be limited specifically to a transponder or transceiver device, but to any electronic device or system which has at least the function of transmitting and/or receiving wireless signals, including all microprocessor, memory or other electronic components associated therewith.

Throughout the description and claims of this specification, the words “comprise” and contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers and characteristics described in conjunction with a particular aspect, embodiment or example of the invention are to be understood to be applicable to any other aspect, embodiment or example described herein unless incompatible therewith.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A case for a mobile telephone or other nomadic device, the case comprising a transceiver or transponder system for wirelessly communicating with a security and/or access system of a vehicle or property.

2. A case as claimed in claim 1, wherein the transceiver or transponder system is arranged to communicate with a Keyless Vehicle Module (KVM) or other vehicle security system so as to permit access to a vehicle.

3. A case as claimed in claim 1, wherein the case is adapted to receive and at least partially surround a mobile telephone or other nomadic device in a detachable or removable manner.

4. A case as claimed in claim 1, wherein the transceiver or transponder system comprises a PCB or other substrate on which one or more electronic components is mounted.

5. A case as claimed in claim 1, wherein the case is formed from a generally flexible and/or soft elastomeric or plastics material such as rubber, rubberized gel.

6. A case as claimed in claim 5, wherein the transceiver or transponder system is formed integrally with, or embedded within, the material forming the case.

7. A case as claimed in claim 1, wherein the case is formed from a rigid or semi-rigid plastics material such as PET, HDPE, PVC or PP comprising a slot or recess for locating or retaining the transceiver or transponder system.

8. A case as claimed in any claim 7, wherein the slot or recess is disposed in or on a rear cover portion of the case.

9. A case as claimed in claim 7, wherein the slot or recess is adapted to receive a PCB or other supporting structure on which the transceiver or transponder system is mounted.

10. A case as claimed in claim 1, wherein the transceiver or transponder system comprises an RFID tag.

11. A case as claimed in claim 1, wherein the transceiver or transponder system is arranged to wirelessly communicate with a vehicle ignition system for activating or deactivating the vehicle ignition and/or starting or stopping the vehicle internal combustion engine.

12. A case as claimed in claim 1, wherein the transceiver or transponder system is arranged to transmit control or operation commands to the vehicle, so as to operate or control one or more vehicle functions or devices.

13. A case as claimed in claim 12, further comprising one or more buttons or switches configured to be actuated by the user to operate or control the transceiver or transponder system to transmit the control commands to the vehicle.

14. A case as claimed in claim 13, wherein the case includes one or more buttons or switches for controlling or actuating one or more of the vehicle functions or devices.

15. A case as claimed in claim 12, wherein the case is arranged to reduce and/or prevent unintended transmission of the control commands to the vehicle.

16. A case as claimed in claim 15, further comprising at least one button or switch for enabling, confirming or otherwise validating the transmission of a control command to the vehicle.

17. A case as claimed in claim 15, wherein the transceiver or transponder system is arranged to delay or prevent transmission of the control command following actuation of the one or more buttons until an enable or confirm button has been actuated.

18. A case as claimed in claim 15, wherein the transceiver or transponder system is arranged to delay or prevent transmission of the control command following actuation of one of the buttons until said button has been actuated a predetermined number of times in a predetermined time period.

19. A mobile telephone or other nomadic device having a case as claimed in claim 1.

20. A vehicle adapted to work with a mobile telephone or other nomadic device having a case as claimed in claim 1.
